(19) United States
(12) Patent Application Publication
(10) Pub. No.: US 2005/0151832 A1
(43) Pub. Date: Jul. 14, 2005

(54) Methods and apparatus for splitting a printer cartridge

(76) Inventor: Jonathan Martin, Fayetteville, NC (US)

Correspondence Address: WILLIAM L. LONDON, 3010 LEE AVENUE, P.O. BOX 152, SANFORD, NC, 27330, US

(21) Appl. No.: 10/754,942

(22) Filed: Jan. 9, 2004

(51) Int. Cl. B41J 2/47

(52) U.S. Cl. 347/240

(57) ABSTRACT

Techniques are provided for splitting a printer cartridge. In one aspect, a cartridge splitter includes guide rails for supporting a toner cartridge having a first portion and a second portion. A first cutting blade is disposed in a first plane of operation for cutting the toner cartridge along the first plane as the toner cartridge is moved along the guide rails. A second cutting blade disposed in a second plane of operation for cutting the toner cartridge along the second plane as the toner cartridge is moved along the guide rails, said second plane of operation offset from the first plane of operation by a predetermined distance such that the cutting of the toner cartridge along the first plane and the second plane separates the first portion from the second portion.

### BACKGROUND

The present invention relates generally to remanufacturing printer cartridges, and more particularly to techniques for splitting a printer cartridge during the remanufacturing process.

In the printing industry, there is a growing market for the remanufacture and refurbishing of various types of printing components such as toner cartridges, ink cartridges, magnetic rollers, seals, and the like. Toner cartridges, once spent, are unusable for their originally intended purpose. Without a refurbishing process, they would simply be discarded, even though the cartridge itself may still have potential life. As a result, techniques have been developed specifically to address this issue. These processes may entail, for example, the disassembly of the various structures of the cartridge, replacing toner, cleaning, adjusting or replacing any worn components and reassembling the cartridge.

During transportation, printer toner cartridges are subject to leakage of toner from the toner hopper unless the opening of the toner hopper is sealed. For example, the toner hopper opening of the HP4600 toner cartridge is sealed by heat bonding a film material around the perimeter of the hopper opening. An extension is provided on one side of this film and is doubled back over the seal area, extending outside of the cartridge housing on one side of the cartridge. Prior to initial usage of the cartridge, the end user grasps the portion of the film, which extends outside the cartridge and pulls it. This action peels the film away from the hopper, uncovering the opening and allowing the toner to flow into the development mechanism of the cartridge.

During subsequent refurbishment of toner cartridges, it becomes necessary to reseal the hopper after it is refilled with toner. However, construction of the hopper is such that adequate access to the seal area for seal replacement often does not exist. In the case of the HP4600, the original manufacturer ultrasonically welded the developer roller housing to the hopper, attaching it directly over the hopper seal area. To gain access to the seal area for seal replacement, it is necessary to remove the developer roller housing from the toner hopper.

### SUMMARY

In accordance with an embodiment of the present invention, techniques are provided for splitting a printer cartridge. In one aspect of the present invention, a cartridge splitter includes guide rails for supporting a toner cartridge having a first portion and a second portion. A first cutting blade is disposed in a first plane of operation for cutting the toner cartridge along the first plane as the toner cartridge is moved along the guide rails. A second cutting blade disposed in a second plane of operation for cutting the toner cartridge along the second plane as the toner cartridge is moved along the guide rails. The second plane of operation is offset from the first plane of operation by a predetermined distance such that the cutting of the toner cartridge along the first plane and the second plane separates the first portion from the second portion.

In another aspect of the present invention, a method of splitting a cartridge includes the steps of providing a toner cartridge splitting apparatus including a first cutting device for cutting in a first plane and a second cutting device for cutting in a second plane which is offset from the first plane. Toner cartridge is moved adjacent the first and second cutting devices, where the first cutting device cuts the toner cartridge in the first plane and the second cutting device cuts the toner cartridge in the second plane. The first portion of the toner cartridge is then separated from the second portion of the toner cartridge.

A more complete understanding of the present invention, as well as further features and advantages of the invention, will be apparent from the following detailed description and the accompanying drawings.

### BRIEF DESCRIPTION OF THE DRAWINGS

FIG. 1 shows a perspective view of a toner hopper assembly of a toner cartridge;

FIG. 2 shows a perspective view of a split toner hopper assembly of a toner cartridge in accordance with the present invention;

FIG. 3 shows a cross sectional view of a toner hopper assembly of a toner cartridge;

FIG. 4 shows a cross sectional view of a split toner hopper assembly of a toner cartridge in accordance with the present invention;

FIG. 5 shows a toner cartridge splitter in accordance with the present invention; and

FIG. 6 shows a cross sectional view of a toner hopper assembly held by guide rails.

### DETAILED DESCRIPTION

The following detailed description of preferred embodiments refers to the accompanying drawings which illustrate specific embodiments of the invention. In the discussion that follows, specific techniques for splitting an HP4600 toner printer cartridge are disclosed. Other embodiments having different structures and operations for the splitting of other types of cartridges for use with other types of printers do not depart from the scope of the present invention. For example, the techniques of the present invention may be adapted to split an HP5500 toner cartridge.

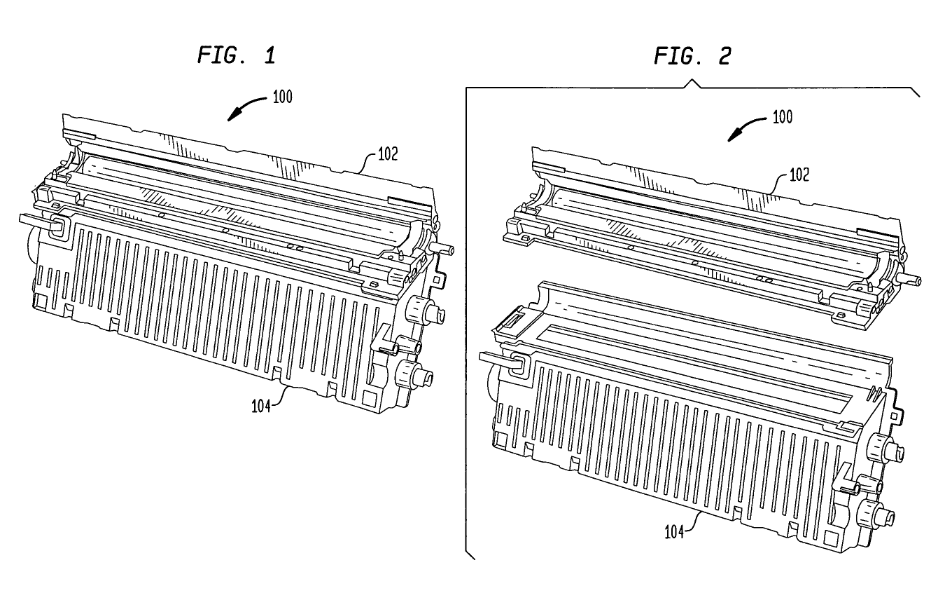

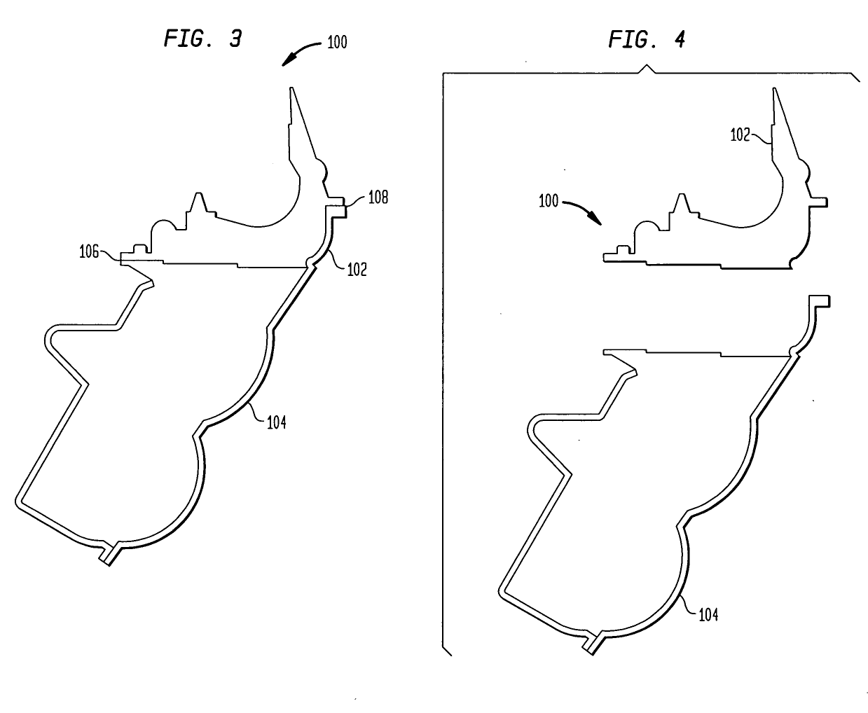

FIG. 1 shows a perspective view of a toner hopper assembly 100 of a toner cartridge, specifically an HP4600 toner cartridge. The toner hopper assembly 100 comprises a developer roller housing 102 and a toner hopper 104. As seen more clearly in the cross sectional view of the toner hopper assembly 100 shown in FIG. 3, the developer roller housing 102 is attached to the toner hopper 104 by ultrasonic welds along seams 106 and 108. To gain access to the seal area of the toner hopper 104 during the remanufacturing process, it is necessary to separate the developer roller housing 102 from the toner hopper 104.

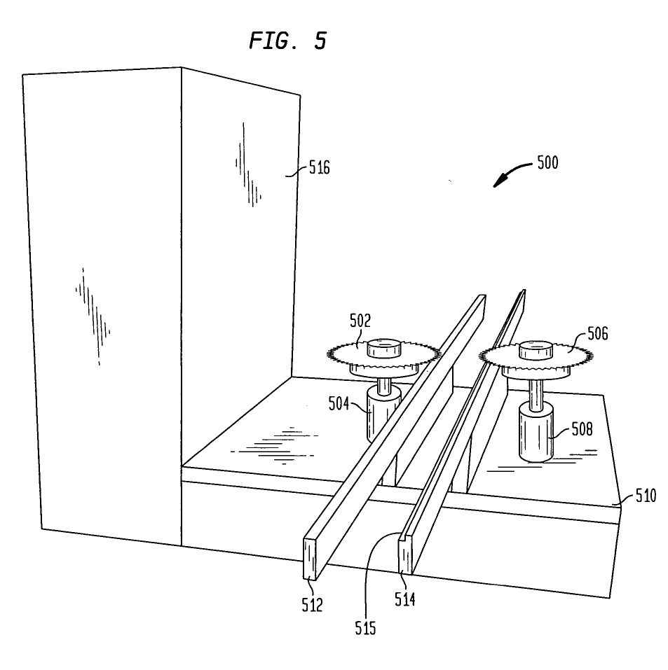

As described in greater detail below, in one aspect of the present invention techniques are provided for separating the developer roller housing 102 from the toner hopper 104. FIGS. 2 and 4 show a perspective view and a cross sectional view, respectively, of the toner hopper assembly 100 after the developer roller housing 102 has been split, or separated, from the toner hopper along seams 106 and 108 in accordance with the present invention. In a preferred embodiment, this splitting is achieved by cutting or breaking the ultrasonic welds that secure the developer roller housing 102 to the toner hopper 104.

FIG. 5 shows a toner cartridge splitter 500 in accordance with the present invention. The toner cartridge splitter 500 comprises a first circular saw blade 502 mounted on a bearing supported arbor 504 and a second circular saw blade 506 mounted on a bearing supported arbor 508. The bearing supported arbors 504 and 508 are attached to a base plate 510. Guide rails 512 and 514 are mounted on the base plate 510 and are precisely positioned to maintain the toner cartridge assembly 100 in the correct position with respect to the first circular saw blade 502 and the second circular saw blade 506 as the toner cartridge assembly 100 is being split. The blade arbors 504 and 508 may be suitably driven by an electric motor disposed within housing 516. As would be understood by one of skill in the art, belts, gears, or the like may be utilized to mechanically couple the electric motor to the blade arbors 504 and 508. Guide rail 514 may suitably a recess 515 running along the length of the rail to accommodate pins extending from the toner hopper assembly 100.

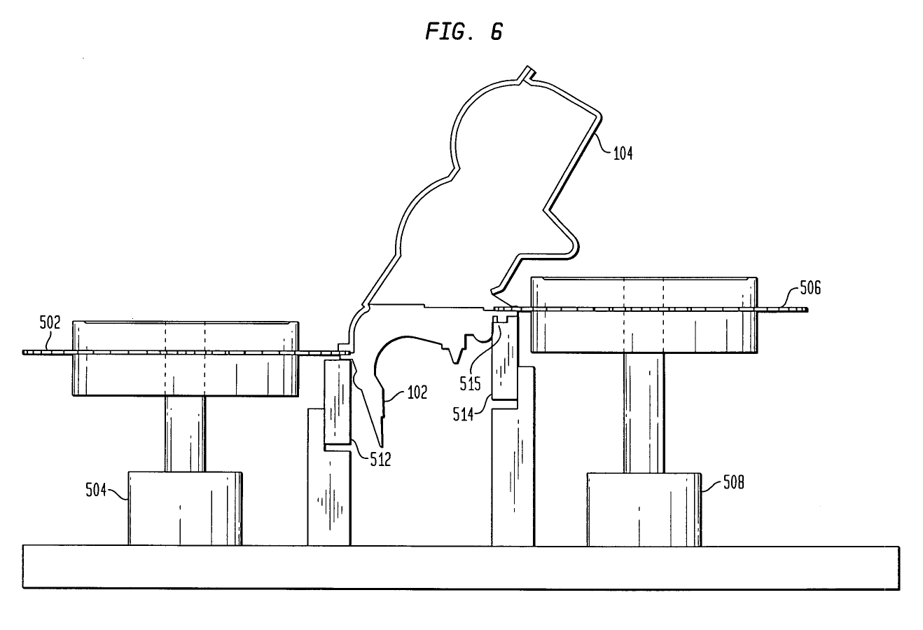

To separate the developer roller housing 102 from the toner hopper 104, the toner hopper assembly 100 is first placed onto the guide rails 512 and 514. Then the toner hopper assembly 100 is moved along the guide rails 512 and 514 past the circular blades 502 and 506 which perform the cutting operation to split the toner hopper assembly 100. As seen more clearly in FIG. 6, the first circular blade 502 cuts, or rotates, in a first plane of operation to remove a thin layer of material from ultrasonic weld joint 106, while the second circular blade 506 cuts, or rotates in a second plane of operation to remove a thin layer of material from ultrasonic weld joint 108. The second plane of operation is offset from the first plane of operation by a predetermined distance which, in conjunction with the placement of the guide rails 512 and 514, appropriately aligns the toner hopper assembly 100 for splitting by the circular blades 502 and 506. In a preferred embodiment for the splitting of an HP4600 cartridge, the first plane of operation is offset from the second plane of operation by approximately 0.537 inches, and the circular blades 502 and 506 each remove a layer of material from the ultrasonic welds 106 and 108 which is approximately 0.023 inches thick. Other cutting plane offset distances and cut thicknesses may be used depending on the specific dimensions and construction of the cartridge being split.

In an alternate embodiment, the guide rails 512 and 514 may hold the toner hopper assembly 100 in a fixed position and the circular blades 502 and 506 may move past the toner hopper assembly 100.

Although specific embodiments have been illustrated and described herein, those of ordinary skill in the art appreciate that any arrangement which is calculated to achieve the same purpose may be substituted for the specific embodiments shown and that the invention has other applications in other environments. For example, other cutting techniques such as knife blades, jigsaw cutters, and the like may be utilized to perform the cutting operation. This application is intended to cover any adaptations or variations of the present invention. The following claims are in no way intended to limit the scope of the invention to the specific embodiments described herein.

1. A printer cartridge splitting apparatus comprising:
first cutting means for cutting in a first plane;
second cutting means for cutting in a second plane offset from the first plane by a predetermined distance; and
means for supporting a printer cartridge in position for the first and second cutting means to split the printer cartridge by cutting along the first and second planes.

2. The printer cartridge splitting apparatus of claim 1 wherein the printer cartridge comprises a first portion and a second portion, said first portion attached to said second portion along first and second seams, and wherein the first cutting means is positioned to cut the printer cartridge along the first seam and the second cutting means is positioned to cut the printer cartridge along the second seam.

3. The printer cartridge splitting apparatus of claim 2 wherein the first cutting means is adapted to remove a thin layer of material along the first seam, and the second cutting means is adapted to remove a thin layer of material along the second seam.

4. The printer cartridge splitting apparatus of claim 2 wherein:
the first portion comprises a developer roller housing; and
the second portion comprises a toner hopper.

5. The printer cartridge splitting apparatus of claim 1 wherein means for supporting comprises means for engaging pins extending from the printer cartridge.

6. A toner cartridge splitting apparatus comprising:
guide rails for supporting a toner cartridge, said toner cartridge comprising a first portion and a second portion;
a first cutting blade disposed in a first plane of operation for cutting the toner cartridge along the first plane as the toner cartridge is moved along the guide rails; and
a second cutting blade disposed in a second plane of operation for cutting the toner cartridge along the second plane as the toner cartridge is moved along the guide rails, said second plane of operation offset from the first plane of operation by a predetermined distance such that the cutting of the toner cartridge along the first plane and the second plane separates the first portion from the second portion.

7. The toner cartridge splitting apparatus of claim 6 wherein the first portion is attached to the second portion along first and second seams, and wherein the first cutting means is positioned to cut the toner cartridge along the first seam and the second cutting means is positioned to cut the printer cartridge along the second seam.

8. The toner cartridge splitting apparatus of claim 7 wherein the first cutting blade is adapted to remove a thin layer of material along the first seam, and the second cutting blade is adapted to remove a thin layer of material along the second seam.

9. The toner cartridge splitting apparatus of claim 6 wherein:
the first portion comprises a developer roller housing; and
the second portion comprises a toner hopper.

10. The toner cartridge splitting apparatus of claim 1 wherein at least one of the guide rails comprises a recess for engaging pins extending from the printer cartridge.

11. A method of splitting a toner cartridge comprising a first portion and a second portion, the method comprising:
providing a toner cartridge splitting apparatus comprising a first cutting device for cutting in a first plane and a second cutting device for cutting in a second plane offset from the first plane;
moving the toner cartridge adjacent the first and second cutting devices, said first cutting devices cutting the toner cartridge in the first plane, said second cutting device cutting the toner cartridge in the second plane; and
separating the first portion of the toner cartridge from the second portion of the toner cartridge.

12. The method of claim 11 wherein the first portion comprises a developer roller housing and the second portion comprises a toner hopper.

13. The method of claim 12 wherein the first portion is attached to the second portion along first and second seams, and said first cutting device separates the first portion from the second portion along the first seam, and said second cutting device separates the first portion from the second portion along the second seam.

14. The method of claim 11 wherein the toner cartridge splitter further comprises a guiding device for holding the toner cartridge, the method further comprising, after the step of providing, the step of:
placing the toner cartridge onto the guiding device.

15. The method of claim 14 wherein the step of moving further comprises the substep of:
sliding the toner cartridge along the guiding device.
